(19) United States
(12) Patent Application Publication
(10) Pub. No.: US 2014/0117805 A1
(43) Pub. Date: May 1, 2014

(54) Rotating Machine and Insulator and Slot Liner for Rotating Machine

(71) Applicants: Shuya Hagiwara, Tokyo (JP); Koji Obata, Tokyo (JP); Yoshimi Kurahara, Tokyo (JP)

(72) Inventors: Shuya Hagiwara, Tokyo (JP); Koji Obata, Tokyo (JP); Yoshimi Kurahara, Tokyo (JP)

(73) Assignee: Hitachi Automotive Systems, Ltd., Hitachinaka-shi, Ibaraki (JP)

(21) Appl. No.: 14/123,588

(22) PCT Filed: Jun. 15, 2012
(86) PCT No.: PCT/JP2012/065344

§ 371 Date: Dec. 3, 2013

(30) Foreign Application Priority Data
Jun. 23, 2011 (JP) 2011-139702

(51) Int. Cl. H02K 3/34

(52) U.S. Cl. CPC H02K 3/345
USPC 310/215

(57) ABSTRACT

A rotating machine includes a stator including a stator core having a plurality of slots arrayed in the circumferential direction, a plurality of conductors for stator winding wire inserted respectively into the slots, and slot liners comprising a sheet-shaped insulator surrounding the conductors for stator winding wire; and a rotor rotatably arranged concentrically with the stator. In the rotating machine the slots of which are filled with an electrically insulative resin, concavo-convex is formed on both the top and bottom surfaces of the slot liners.

### TECHNICAL FIELD

The present invention relates to a rotating machine, an insulator for the rotating machine, and a slot liner used in the rotating machine.

### BACKGROUND ART

A rotating machine such as a motor closely related to industry and daily living is infrastructure equipment sustaining modern society. Among such rotating machines, in a rotating machine operated at a relatively low voltage, magnet wire is used for coil winding. When a coil is incorporated into a slot formed in a stator core, necessary insulation performance is secured by installing an insulator called a slot liner in the slot so as to cover magnet wire and fastening the magnet wire, the slot liner, and the stator core with varnish (refer to Patent Literatures 1 and 2 for example).

### CITATION LIST

### Patent Literature

Patent Literature 1: Japanese Unexamined Patent Application Publication No. Hei11 (1999)-299156
Patent Literature 2: Japanese Unexamined Patent Application Publication No. 2009-195009

### SUMMARY OF INVENTION

### Technical Problem

Meanwhile, a hybrid vehicle and an electric vehicle become widespread for the conservation of the global environment and a rotating machine employing such an insulation system as stated above is used as a drive source for such a vehicle. A rotating machine for an automobile tends to cause larger vibrations during operation in comparison with a rotating machine used at home or a factory because vibrations by running are added to the vibrations caused by electromagnetic force and rotating eccentric force of the rotating machine. Consequently, in the case where a force accompanying vibrations is added to a rotating machine employing an insulation system formed by fastening magnet wire and a slot liner with varnish, the magnet wire vibrates if a fastened part exfoliates and hence that may undesirably damage the insulation layer of the magnet wire mechanically and lead to electrical breakdown.

### Solution to Problem

According to the first embodiment of the present invention, in a rotating machine comprising a stator including a stator core having a plurality of slots arrayed in the circumferential direction, a plurality of conductors for stator winding wire inserted respectively into the slots, and slot liners comprising a sheet-shaped insulator surrounding the conductors for stator winding wire and a rotor rotatably arranged concentrically with the stator, the slots being filled with an electrically insulative resin, concavo-convex is formed on both the top and bottom surfaces of the slot liners.

According to the second embodiment of the present invention, in a rotating machine according to the first embodiment, it is preferable that: the slot liners are installed respectively from ends to the other ends of the slots extending from an end to the other end of the stator core in the axial direction; and concave parts constituting the concavo-convex communicate from the ends to the other ends of the slots.

According to the third embodiment of the present invention, in a rotating machine according to the second embodiment, it is preferable that concave parts and convex parts constituting the concavo-convex extend respectively in the axial direction of the stator core.

According to the fourth embodiment of the present invention, in a rotating machine according to the second embodiment, it is preferable that concave parts and convex parts constituting the concavo-convex extend respectively in the manner of being skewed to the axial direction of the stator core.

According to the fifth embodiment of the present invention, in a rotating machine according to the third or fourth embodiment, it is preferable that the concavo-convex has a wavy concavo-convex shape or an embossed concavo-convex shape.

According to the sixth embodiment of the present invention, in a sheet-shaped insulator for a rotating machine used for the electrical insulation of stator winding wire of the rotating machine: the insulator is an insulating sheet comprising at least either of a polymer film and fibrous nonwoven paper; and concavo-convex is formed on both the top and bottom surfaces of the insulating sheet.

According to the seventh embodiment of the present invention, in an insulator for a rotating machine according to the sixth embodiment, it is preferable that the concavo-convex has a wavy concavo-convex shape or an embossed concavo-convex shape.

According to the eighth embodiment of the present invention: a slot liner is arranged in a slot formed in a stator of a rotating machine and formed by folding an insulator for a rotating machine according to the sixth or seventh embodiment into a cylindrical shape; and concave parts and convex parts of the concavo-convex extend in the axial direction of the cylindrical slot liner.

### Advantageous Effects of Invention

The present invention makes it possible to improve the insulation reliability of a rotating machine.

### BRIEF DESCRIPTION OF DRAWINGS

FIG. 1 is a view showing a rotating machine according to an embodiment of the present invention and is a half section including a rotating shaft of the rotating machine.

FIG. 2 is a sectional view taken on line IV-IV′ in FIG. 1.

FIG. 3 is an enlarged view of the part of a slot 31 in FIG. 2.

FIG. 4 is a view explaining the surface shape of a slot liner 1a.

FIG. 5 is a perspective view showing a part of a stator coil 41a covered with a slot liner 1a.

FIG. 6 is a view explaining an example in the measurement of the adhesive force of varnish.

FIG. 7 is a view explaining the relationship between the magnitude of concavo-convex and a contact area.

FIG. 8 is a view showing a first example of insulating paper 61 used for a slot liner 1.

FIG. 9 is a view showing a second example of insulating paper 61 used for a slot liner 1.

FIG. 10 is a view showing a third example of insulating paper 61 used for a slot liner 1.

FIG. 11 is a view explaining the case where the extending direction R of the concavo-convex of a slot liner 1 is nearly identical to the extending direction R1 of a slot 31.

FIG. 12 is a view explaining the case where the extending direction R of the concavo-convex of a slot liner 1 is skewed to the extending direction R1 of a slot 31.

FIG. 13 is a view explaining the filling of varnish in the case of using a slot liner 100 having no concavo-convex.

FIG. 14 is a perspective view showing insulating paper 61 when the surfaces of concavo-convex comprise flat surfaces.

### DESCRIPTION OF EMBODIMENTS

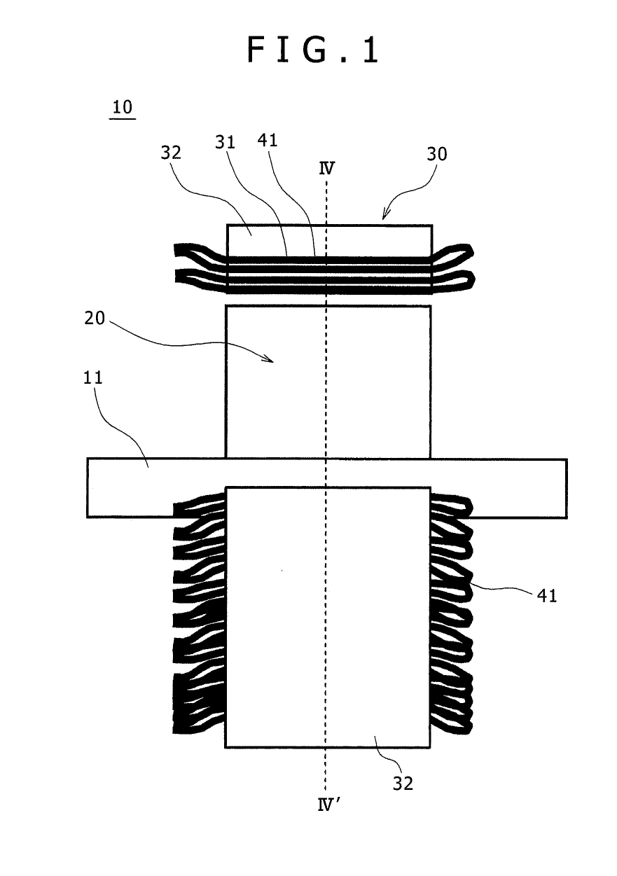

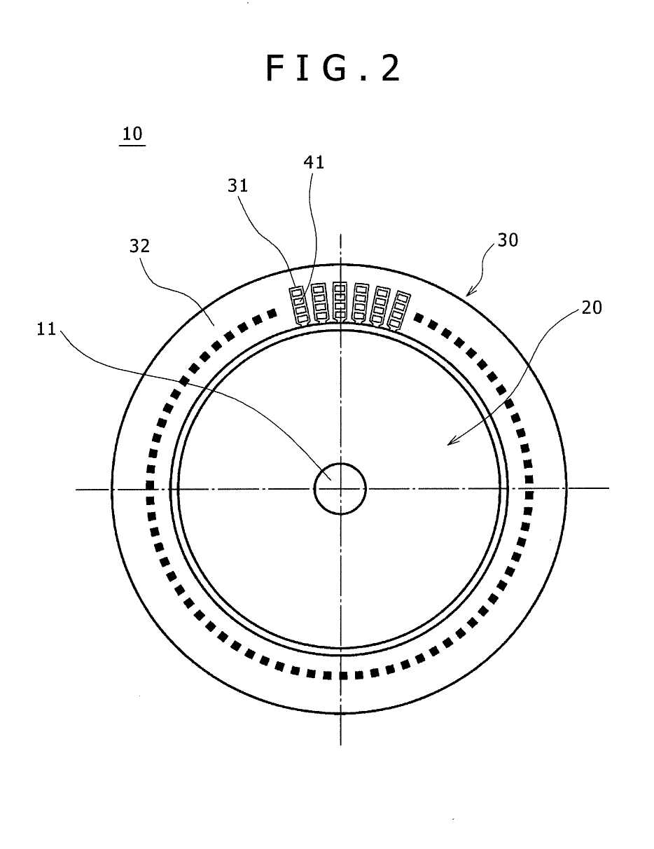

Embodiments according to the present invention are hereunder explained in reference to drawings. FIGS. 1 and 2 are views explaining an embodiment of a rotating machine according to the present invention and show the whole configuration of the rotating machine. FIG. 1 is a half section including a rotating shaft 11 of a rotating machine 10. FIG. 2 is a sectional view taken on line IV-IV′ in FIG. 1. In the present embodiment, explanations are made on the basis of the case of using a permanent-magnet rotating machine as a rotating machine.

As shown in FIGS. 1 and 2, a rotor 20 and a stator 30 are arranged concentrically. Here, although it is not shown in the figures, a permanent magnet is embedded into the rotor 20. A plurality of slots 31 are formed in a stator core 32 of the stator 30 in the circumferential direction and a stator coil 41 is incorporated into each of the slots 31. Electric power is supplied to the stator coils 41 through connecting terminals not shown in the figures and a magnetic field is generated thereby.

Several tens of the slots 31 and the stator coils 41 are usually allocated respectively at equal intervals in the circumferential direction of the stator 30 but here only parts of them are shown in the figures. Here, although four stator coils 41 having a rectangular sectional shape are incorporated into a slot 31 in the example shown in FIG. 2, the shape and the number of the coils are not limited to the example. A torque is generated in the rotor 20 by interaction between a magnetic field generated by electric current flowing in the stator coils 41 and a magnetic field of the permanent magnet embedded into the rotor 20.

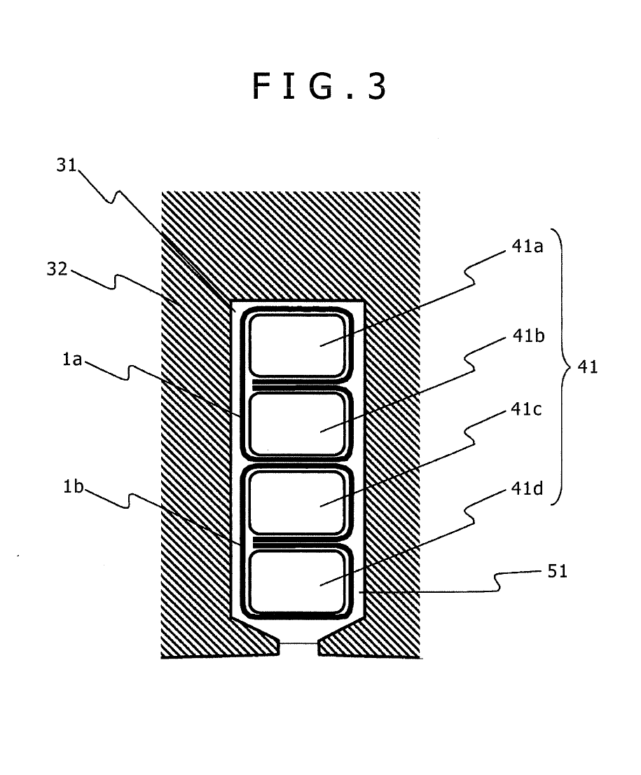

FIG. 3 is an enlarged view of the part of a slot 31 in FIG. 2. Four stator coils 41 (41a, 41b, 41c, and 41d) installed in the slot 31 are enclosed by slot liners 1a and 1b comprising a sheet-shaped insulator (hereunder referred to as insulating paper). A configuration of surrounding two coils by a slot liner is shown here in the manner of installing the slot liner 1a for the stator coils 41a and 41b on the outer circumference side and the slot liner 1b for the stator coils 41c and 41d on the inner circumference side. The slot liner 1a is folded in the manner of surrounding the four sides of the respective stator coils 41a and 41b. Likewise, the slot liner 1b is folded in the manner of surrounding the four sides of the respective stator coils 41c and 41d.

Here, electric wire produced by coating the surface of a conductor having a rectangular section generally called rectangular magnet wire with an enamel film is preferably used as the stator coils 41a, 41b, 41c, and 41d. Further, insulating paper called laminated insulating paper formed by sticking heat-resistant fibrous nonwoven paper together on both the surfaces of a polymer film is preferably used as the slot liners 1a and 1b. The slot liners 1a and 1b are formed by folding the laminated insulating paper.

The space of the slot 31 excluding the stator coils 41a to 41d and the slot liners 1a and 1b is filled with varnish 51 for insulation. The varnish 51 is a resin having electrical insulation and epoxy resin, heat-resistant alkyd resin, unsaturated polyester resin, etc. are used. The stator coils 41a to 41d and the slot liners 1a and 1b are fixed to the stator core 32 by hardening the varnish 51. A thermosetting resin that is in the form of a liquid when the slot 31 is filled and hardens by applying heat after the filling is preferably used as the varnish 51.

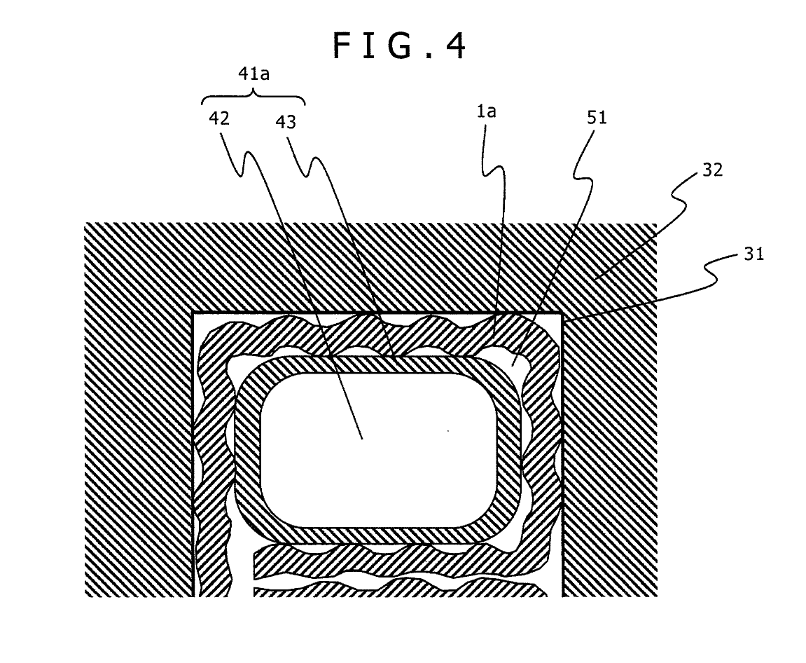

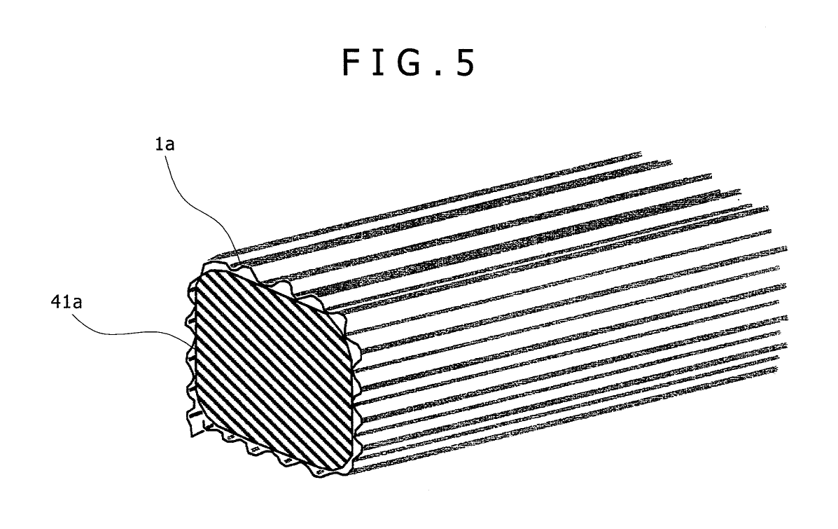

FIG. 4 is a view further enlarging a part shown in FIG. 3 so as to easily understand the surface shape of the slot liner 1a. Further, FIG. 5 is a perspective view showing a part of the stator coil 41a covered with the slot liner 1a. Here, although the slot liner 1a around the stator coil 41a is shown in FIGS. 4 and 5, the slot liners around the stator coils 41b to 41d have the same configuration.

Although both the top and bottom surfaces of the slot liners 1a and 1b are described planarly in an abbreviated manner in FIG. 3, the detailed shape of the surfaces is a concavo-convex shape as shown in FIG. 4. The stator coil 41a comprises a conductor 42 and an enamel film 43 covering the conductor 42. Concave parts and convex parts formed on both the top and bottom surfaces of the slot liner 1a extend in lines in the extending direction of the stator coil 41a, namely in the extending direction of the slot 31 extending in the axial direction of the stator core 32, as shown in FIG. 5.

A gap between the slot liner 1a and a slot inner wall, a gap between the slot liner 1a and the stator coil 41, and a gap between adjacent slot liners are filled with varnish 51 respectively. A feature of the present embodiment is that both the top and bottom surfaces of the slot liners 1a and 1b have a concavo-convex shape and it is thereby possible to increase a contact area between the slot liners 1a and 1b and the varnish 51 in comparison with the case where the surfaces of a slot liner have a planar shape.

Meanwhile, as stated earlier, vibrations are generated by electromagnetic force varying temporally by the interaction of magnetic fields, vibrations accompanying rotation, and others in a stator coil of a rotating machine under operation. Further, a rotating machine mounted on a movable body such as an automobile undergoes vibrations from outside. Under such vibrations, the varnish 51 plays a role of fixing the stator core 32 and the stator coil 41 so as not to be displaced relatively. If the adhesive force of the varnish 51 is insufficient therefore, exfoliation occurs at an adhesive site by the electromagnetic force and inertial force accompanying the vibrations and the stator core 32 and the stator coil 41 slide and are displaced relatively. If such slide is repeated for a long period of time, mechanical damages are caused in the enamel film 43 of the stator coil 41 and necessary insulation performance may not be maintained undesirably.

The present inventors have found that the interface adhesive force between the hardened varnish 51 and the slot liners 1a and 1b is inferior to the interface adhesive force between the hardened varnish 51 and the magnet wire (stator coil 41) with regard to the exfoliation at the adhesive site during the course of evaluating the characteristics of an insulation system formed by fastening magnet wire and insulating paper constituting slot liners with varnish.

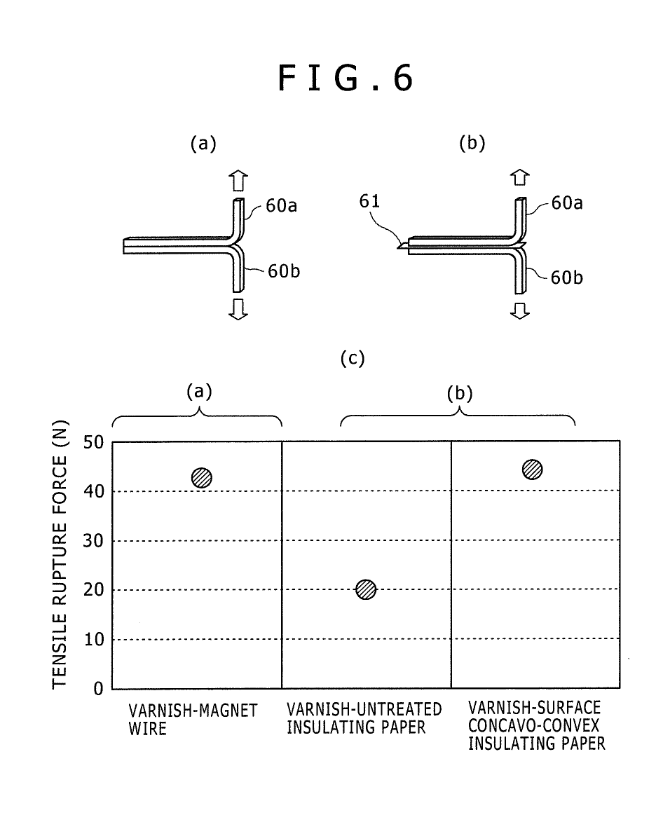

FIG. 6 shows an example in the measurement of the adhesive force of varnish. Here, a specimen having the shape shown in FIG. 6A is compared with a specimen having the shape shown in FIG. 6B. In the case of the shape shown in FIG. 6A, two magnet wires (rectangular wires) 60a and 60b are bonded with varnish. Then, after the varnish is solidified, the magnet wires 60a and 60b are pulled off as shown with the arrows and a tensile rupture force (N) at the time is measured. In the case of the shape shown in FIG. 6B, insulating paper 61 is interposed between magnet wires 60a and 60b, they are bonded respectively with varnish, and a tensile rupture force (N) is measured in the same manner as the case of FIG. 6A. On this occasion, measurement is carried out respectively in the case of forming concavo-convex on both the top and bottom surfaces of insulating paper 61 and in the case of not forming concavo-convex. Here, in the measurement, the surface film of the magnet wires 60a and 60b comprises polyamide imide, the varnish comprises epoxy resin, and the insulating paper 61 comprises aramid fibrous nonwoven paper.

FIG. 6C is a graph showing the measurement results and the measurement data on the left side represent the case of the shape shown in FIG. 6A. Further, the measurement data in the center show the case of the shape shown in FIG. 6B and using insulating paper 61 not having concavo-convex and the measurement data on the right side show the case of the shape shown in FIG. 6B and using insulating paper 61 having concavo-convex.

As shown in FIG. 6C, it is found that the tensile rupture force between varnish and untreated (no concavo-convex) insulating paper is as low as about a half of the tensile rupture force between varnish and magnet wire. On the other hand, it is found that the tensile rupture force between varnish and insulating paper having concavo-convex on the surfaces is nearly identical to the tensile rupture force between varnish and magnet wire. The results show that (1) adhesive force by varnish deteriorates in the case of using insulating paper in comparison with the case of not using insulating paper and (2) a contact area between insulating paper and varnish increases by forming concavo-convex on the surfaces of the insulating paper and adhesive force by the varnish improves in comparison with the case of not having concavo-convex.

Such difference in interface adhesive force has not heretofore been recognized. Since the insulation life of a rotating machine is dominated by a weakest part, in the case of using insulating paper having untreated (no concavo-convex) surfaces as a slot liner as usual, reliability is dominated by the insulation life of the insulating paper and varnish in spite of the fact that the insulation life of magnet wire and varnish has still allowance. In the present embodiment in contrast, since both the top and bottom surfaces of slot liners 1a and 1b have a concavo-convex shape, it is possible to: improve adhesive force further than the conventional case of not having concavo-convex as shown in FIG. 6; and improve the insulation reliability of a rotating machine.

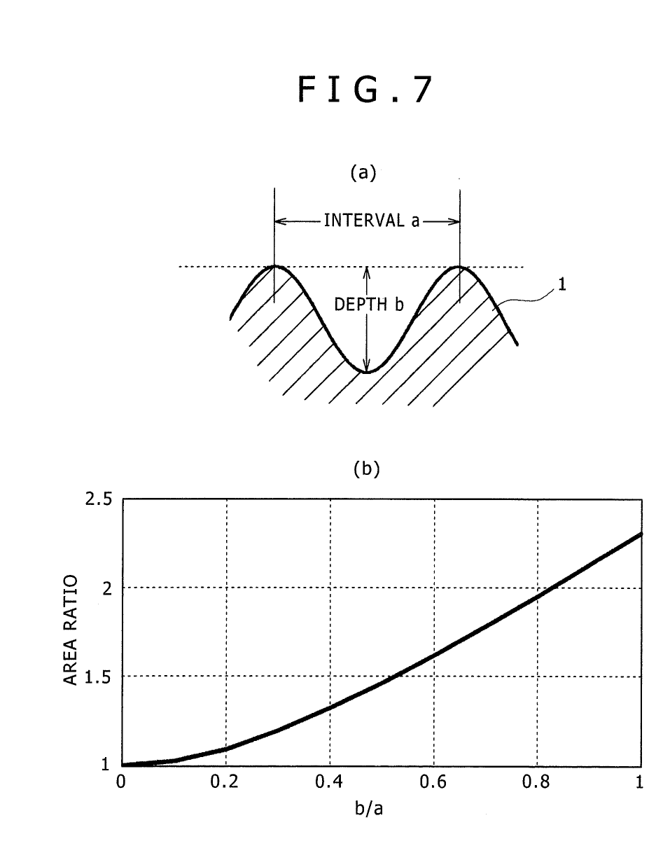

FIG. 7 is a view explaining the relationship between the magnitude of concavo-convex and a contact area and here the explanations are made on the basis of the case of forming concavo-convex surfaces having the shape of a sinusoidal wave as an example. Here, although the term “slot liners” is described in FIG. 3, the slot liners are collectively described as a slot liner 1 hereunder. FIG. 7A shows a surface shape of a slot liner 1 on a cross section perpendicular to the extending direction of concave parts and convex parts. The surface has the shape of a sinusoidal wave. The depth of the concavo-convex is defined as b and an interval between convex parts is defined as a as shown in FIG. 7A. When the ratio b/a is varied, the area ratio obtained by comparing with the case of no concavo-convex is represented by FIG. 7B. The case of b/a=0 corresponds to the case of no concavo-convex and the area ratio on this occasion is 1. As the ratio b/a increases, the area ratio also increases. The interval and depth of concavo-convex may be decided on the basis of the relationship in FIG. 7B in response to a necessary adhesive force.

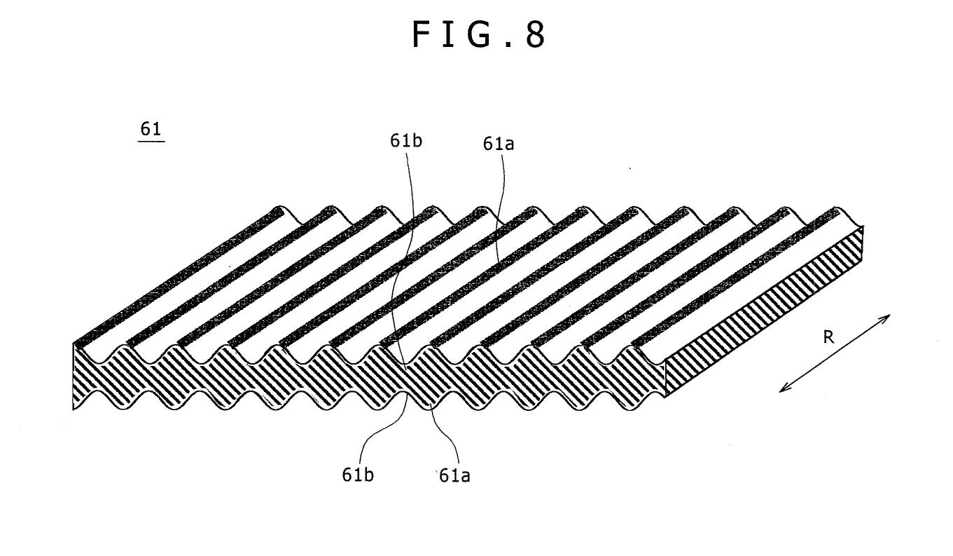

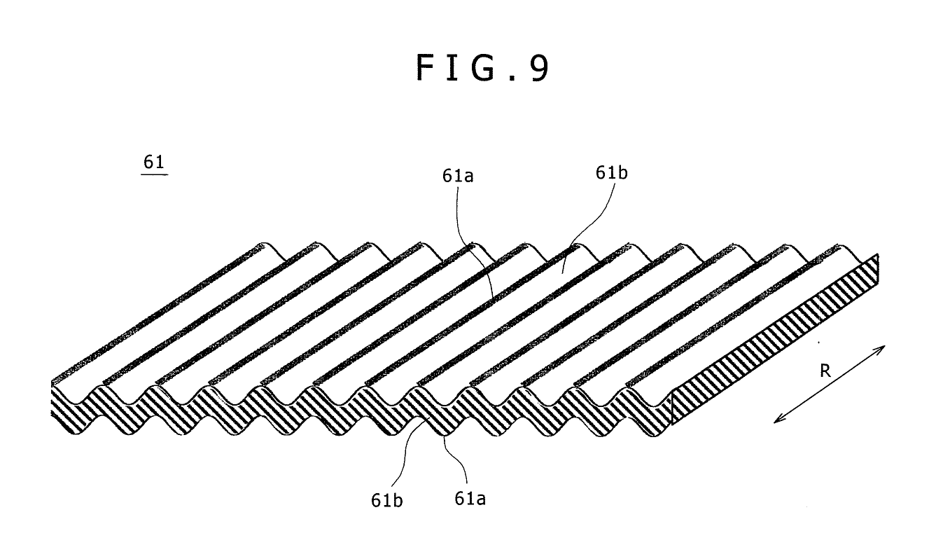

FIGS. 8 to 10 show concrete examples of the surface shape of insulating paper 61 used for a slot liner 1. In the case of the insulating paper 61 shown in FIG. 8, both the top and bottom surfaces have a sinusoidal concavo-convex shape and the phase of the sinusoidal wave is 180 degrees different between the top surface and the bottom surface. As a result, the locations of the convex parts on the top surface and the bottom surface coincide with each other and the locations of the concave parts on the top surface and the bottom surface coincide with each other. Meanwhile, although both the top and bottom surfaces have a sinusoidal concavo-convex shape also in the case of the insulating paper 61 shown in FIG. 9, the phase of the sinusoidal wave is the same between the top surface and the bottom surface. In both the cases of FIGS. 8 and 9, the convex parts 61a and the concave parts 61b are formed so as to extend in the direction shown with the arrow R.

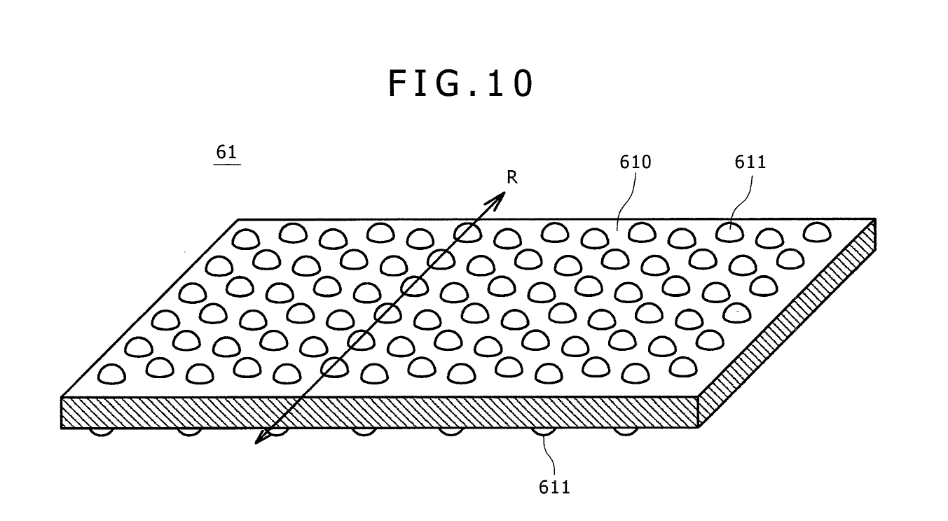

In the case of the insulating paper 61 shown in FIG. 10, both the top and bottom surfaces have a concavo-convex shape formed by embossment. A plurality of semispherical convex parts 611 are formed on both the top and bottom surfaces of the insulating paper 61 in the manner of protruding from a sheet-shaped member 610. The formed convex parts 611 are aligned linearly in the direction indicated with the arrow R. The part of the sheet-shaped member 610 other than the convex parts 611 corresponds to the concave parts 61b in FIGS. 8 and 9. A plurality of convex parts 611 are formed also on the bottom surface of the sheet-shaped member 610 in the same allocation. Here, in the case of the convex parts 611, it is also possible to form the convex parts 611 so as to be linearly aligned not only in the direction indicated with the arrow R but also in another direction. For example, by forming convex parts 611 so as to be aligned on lattice points of a tetragonal lattice, it is possible to linearly align the convex parts 611 in both the R direction and a direction perpendicular to the R direction. It goes without saying that the convex parts 611 may also be formed at random. Here, although the shape, the size, and the arrangement of the convex parts 611 are not restricted, it is desirable to equalize the height to the greatest possible extent.

It is possible to form insulating paper 61 having a surface shape shown in FIGS. 8 to 10 for example by pressing nonwoven paper of aramid fiber that is stated earlier in the manner of interposing the nonwoven paper with a die where many wavy surfaces or semispherical concave surfaces are formed. Further, it is also possible to form sheet-shaped insulating paper having a uniform thickness into a wavy shape. Furthermore, it is possible to use insulating paper formed by sticking two upper and lower layers comprising different materials together or insulating paper of a three-layered structure configured by sticking upper and lower layers and an intermediate layer comprising different materials instead of insulating paper comprising a uniform material. As the material used for insulating paper, a polymer film comprising polyethylene terephthalate or the like and unwoven paper comprising aramid fiber or the like are generally used.

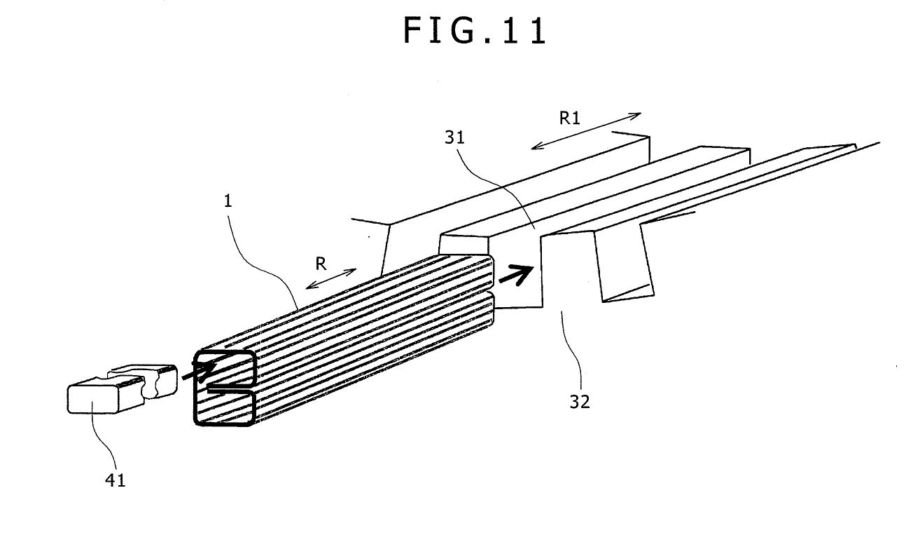

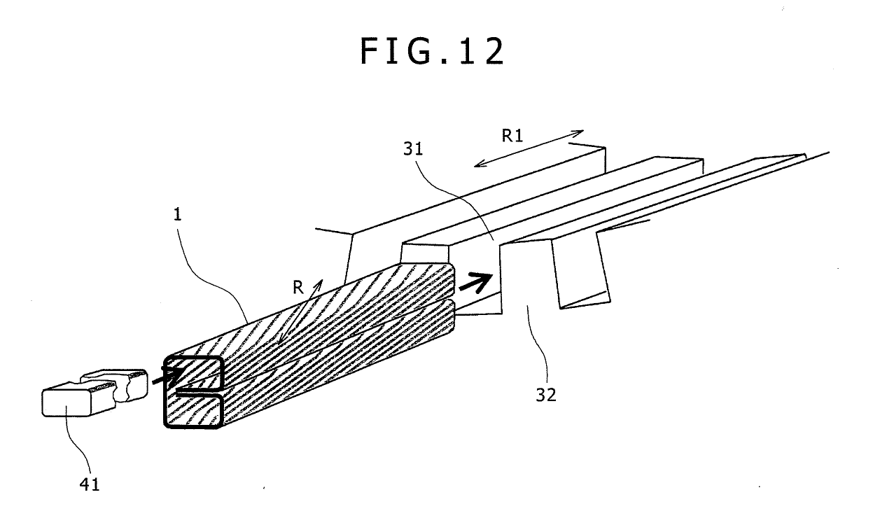

FIGS. 11 and 12 are views explaining the relationship between concavo-convex formed on the surfaces of a slot liner 1 and a slot 31. A slot liner 1 formed by folding insulating paper 61 shown in FIGS. 8 to 10 into a prescribed cylindrical shape is inserted into a slot 31 from an end side of a stator core 32. Successively, a pine-needle-shaped stator coil 41 called a segment coil is installed in the slot 31 in the manner of inserting into a space formed by the slot liner 1.

Meanwhile, when the slot liner 1 is inserted into the slot 31, the folded insulating paper tries to restore the shape and hence the slot liner 1 may hardly be inserted because of friction against a slot inner wall or the like in some cases. Then in such a case, an arising problem is that the slot liner 1 is likely to buckle.

FIGS. 11 and 12 show the case of using insulating paper 61 shown in FIG. 9 as a slot liner 1. In FIG. 11, the slot liner 1 is configured so that the extending direction R of concavo-convex at the time of insertion into a slot may nearly coincide with the extending direction (axial direction of the stator core 32) R1 of the slot 31 in the stator core 32. As a result, the contact area with the slot inner wall and the stator coil 41 reduces and the effect of reducing slide resistance when the slot liner 1 is incorporated into the slot 31 and when the stator coil 41 is inserted into the slot liner 1 is obtained. Further, force is added in the slot extending direction R1 when the slot liner 1 is incorporated into the slot 31. On this occasion, since it is configured so that the extending direction R of the concavo-convex may be nearly identical to the direction of the force, strength against bending and buckling of the slot liner 1 at the time of insertion improves in comparison with the case of a slot liner having no concavo-convex.

Furthermore, the extending direction of the concavo-convex nearly coincides with the slot extending direction R1 and the concave parts forming a varnish filling space pass through the slot 31 in the axial direction. As a result, in a succeeding varnish filling process, it is possible to: fill even the inside of the slot 31 with the varnish; and prevent a space not filled with the varnish from being generated. In general, the stator core 32 is arranged so that the axial direction may be the vertical direction and the slot 31 is filled with the varnish in the manner of dropping the varnish to a core end part. Since the concave parts of the slot liner 1 pass through the interior of the slot 31 in the axial direction, it is possible to: fill the slot 31 up to the back end with the varnish 51 without fail by making use of gravity; and prevent a varnish unfilled space from being generated.

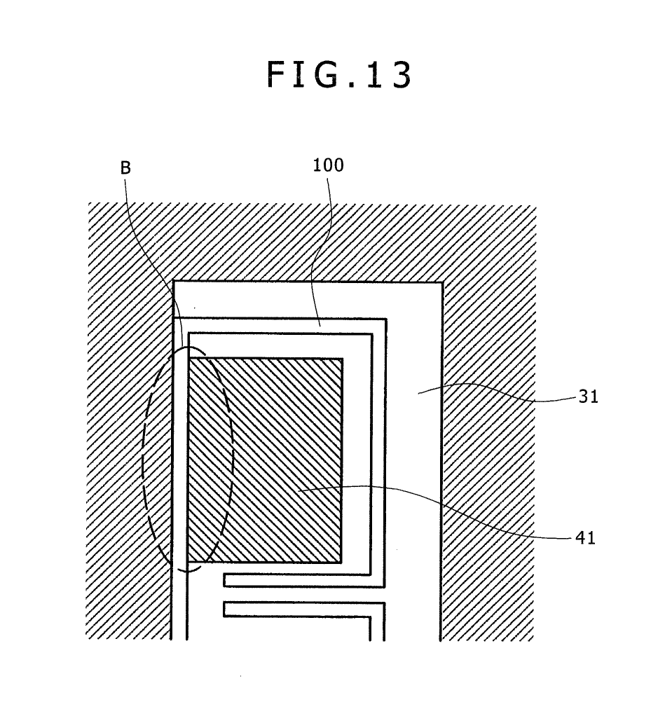

In the case of a slot liner 100 having no concavo-convex as shown in FIG. 13 for example, the slot liner 100 tends to closely touch a slot inner wall and a coil surface like the part shown with the symbol B and varnish filling may undesirably be carried out in the state. If the slot liner 100 closely touches a slot inner wall and a coil surface in a wide region as shown in FIG. 13, a region not filled with varnish tends to be generated even when capillarity is utilized and the insufficiency of adhesive force and the deterioration of insulation cannot be avoided. In the case shown in FIG. 11 in contrast, since the area of the part where a slot liner 1 touches a slot inner wall and a coil surface is small, an unfilled contact part is hardly formed by the effect of the capillarity.

Here, although the apex of a convex part has a curved surface in the concavo-convex shape shown in FIGS. 9 and 10, the apex may also be a flat surface. On that occasion too, the area of the part where a slot liner 1 touches a slot inner wall and a coil surface is small in comparison with a conventional planar contact part and an unfilled contact part is hardly formed.

Further, in the case of a slot liner 1 shown in FIG. 12, the slot liner 1 is configured so that the extending direction R of concavo-convex may be skewed to the slot extending direction R1 (namely, slot insertion direction). In the case of being configured in such a skewed manner too, it is possible to: improve strength against bending and buckling in comparison with the case of a slot liner having no concavo-convex; and obtain the aforementioned effect in varnish filling.

Furthermore, since a concave part filled with varnish 51 is skewed to the slot extending direction, the effect of preventing a stator coil 41 and a slot liner 1 from being displaced in the axial direction is enhanced. Varnish 51 filling a space except a slot liner 1 and a stator coil 41 in a slot 31 comes to be a hardened solid resin by thermal hardening. The adhesive force of the hardened varnish 51 functions as a lock mechanism to prevent displacement of the slot liner 1 and the stator coil 41 in the axial direction, namely to prevent displacement by shear force trying to get out. In the configuration shown in FIG. 12, the hardened varnish 51 is skewed to the slot 31 and the effect of the lock mechanism is enhanced in comparison with the case of FIG. 11.

Here, although the case of using insulating paper 61 shown in FIG. 9 is shown in FIGS. 11 and 12, the same is true in the case of using insulating paper 61 in FIGS. 9 and 10. That is, the extending direction R of convex parts 61a and concave parts 61b in FIG. 9 or the extending direction R of convex parts 611 in FIG. 10 is set in the same manner as the case of FIGS. 11 and 12.

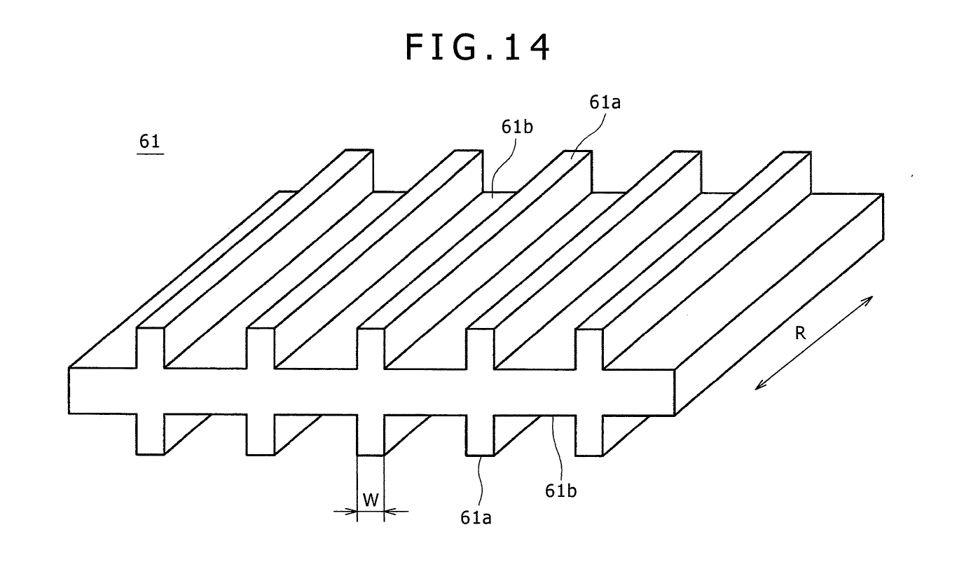

Here, although a sinusoidal shape is used as a concavo-convex shape in FIGS. 8 and 9, a waveform other than the sinusoidal waveform may also be acceptable. Further, it is also possible to form a concavo-convex shape by flat surfaces as shown in FIG. 14 instead of forming a concavo-convex shape by curved surfaces. By reducing the width W of convex parts 61a, it is possible to reduce a contact area when insulating paper closely touches a slot inner wall and a stator coil. Furthermore, although convex parts and concave parts extend linearly, they may be not linear but curvy as long as they pass through a slot 31 in the axial direction.

Furthermore, although explanations have been made on the basis of the case of using rectangular wire having a rectangular section as a stator coil 41 in the above embodiments, a slot liner 1 according to the present embodiment can be applied to a slot liner formed in the manner of enveloping thick round wire and a slot liner formed in the manner of surrounding the circumference of a bundle of round wire. Moreover, a slot liner 1 according to the present embodiment may be applied to a stator coil not coated with enamel.

As stated above, in the present embodiment, in a rotating machine comprising a stator 30 including a stator core 32 having a plurality of slots 31 arrayed in the circumference direction and a plurality of stator coils 41 surrounded by slot liners 1 comprising a sheet-shaped insulator and inserted respectively into the slots 31 and a rotor 20 rotatably arranged concentrically with the stator 30, the slots 31 being filled with varnish 51, concavo-convex is formed on both the top and bottom surfaces of the slot liners 1. As a result, it is possible to: increase a contact area between the slot liners 1 and the varnish 51; and improve adhesive strength between the slot liners 1 and the varnish 51. Consequently, it is possible to: reduce the exfoliation at a contact surface caused by vibrations and the like; and improve insulation reliability.

Further, a slot liner 1 is installed from an end to the other end of each of slots 31 extending from an end to the other end of a stator core 32 in the axial direction and concave parts 61b constituting concavo-convex communicate from an end to the other end of each of the slots 31. By adopting such a configuration, it is possible to: fill the slots 31 up to the back ends in the axial direction with varnish 51 without fail; and prevent a varnish unfilled space from being generated.

Furthermore, by extending concave parts 61b and convex parts 61a constituting concavo-convex of a slot liner 1 respectively in the axial direction of a stator core 32 or extending them in the manner of being skewed in the axial direction, it is possible to increase strength against buckling deformation when the slot liner 1 is inserted into a slot 31. Here, in the case of such an embossed structure as shown in FIG. 10, it is possible to obtain a similar effect by arraying convex parts 611 in the axial direction of a stator core 32 (namely, extending discontinuously) or arraying them in the manner of being skewed to the axial direction.

Moreover, in a cross section perpendicular to the extending direction of concave parts 61b and convex parts 61a of a slot liner 1, by forming concavo-convex so as to have a wavy concavo-convex shape or an embossed concavo-convex shape (convex parts 611), it is possible to: prevent a wide region of the slot liner 1 from closely sticking to a slot inner wall and a stator coil 41; and prevent a region not filled with varnish from being generated.

In addition, in a sheet-shaped insulator (insulating paper 61) for a rotating machine used for electrical insulation of stator winding wire (stator coil 41) of the rotating machine, the insulator is an insulating sheet comprising at least either of a polymer film and fibrous unwoven paper and concavo-convex is formed on both the top and bottom surfaces of the insulating sheet. By installing such an insulating sheet in the manner of surrounding a stator coil 41 arranged in a slot 31 of a stator core 32, it is possible to improve the insulation performance of the rotating machine.

Her, the above explanations are only based on examples and the present invention is not limited to the above embodiments at all as long as the feature of the present invention is not damaged. For example, although a rotating machine of an inner rotor type is used for the explanations in the above examples, the present invention can be applied also to a rotating machine of an outer rotor type.

Although various embodiments and modified examples are explained heretofore, the present invention is not limited to the contents. Other embodiments conceivable in the scope of the technological thought of the present invention are also included in the present invention.

The contents disclosed in the following priority basic application are incorporated herein by reference. Japanese Patent Application No. 2011-139702 (filed on Jun. 23, 2011)

1.-8. (canceled)

9. A rotating machine comprising:
a stator including a stator core having a plurality of slots arrayed in the circumferential direction, a plurality of rectangular magnet wires inserted respectively into the slots, and slot liners including a sheet-shaped insulator surrounding the rectangular magnet wires; and
a rotor rotatably arranged concentrically with the stator, the slots being filled with an electrically insulative resin,
wherein concavo-convex is formed on both the top and bottom surfaces of the slot liners, and the slot liners are installed respectively from ends to the other ends of the slots extending from an end to the other end of the stator core in the axial direction, and
wherein concave parts constituting the concavo-convex communicate from the ends to the other ends of the slots.

10. The rotating machine according to claim 9, wherein concave parts and convex parts constituting the concavo-convex extend respectively in the axial direction of the stator core.

11. The rotating machine according to claim 9, wherein concave parts and convex parts constituting the concavo-convex extend respectively in the manner of being skewed to the axial direction of the stator core.

12. The rotating machine according to claim 10, wherein the concavo-convex has a wavy concavo-convex shape or an embossed concavo-convex shape.

13. The rotating machine according to claim 11, wherein the concavo-convex has a wavy concavo-convex shape or an embossed concavo-convex shape.

14. A sheet-shaped insulator for a rotating machine used for the electrical insulation of stator winding wire of the rotating machine, wherein:
the insulator is an insulating sheet comprising at least either of a polymer film and fibrous nonwoven paper; and
concavo-convex is formed on both the top and bottom surfaces of the insulating sheet.

15. The insulator for a rotating machine according to claim 14, wherein the concavo-convex has a wavy concavo-convex shape or an embossed concavo-convex shape.

16. A slot liner arranged in a slot formed in a stator of a rotating machine and formed by folding an insulator for a rotating machine according to claim 14 into a cylindrical shape, wherein concave parts and convex parts of the concavo-convex extend in the axial direction of the cylindrical slot liner.

17. A slot liner arranged in a slot formed in a stator of a rotating machine and formed by folding an insulator for a rotating machine according to claim 15 into a cylindrical shape, wherein concave parts and convex parts of the concavo-convex extend in the axial direction of the cylindrical slot liner.
